(19) United States
(12) Patent Application Publication
(10) Pub. No.: US 2025/0229372 A1
(43) Pub. Date: Jul. 17, 2025

(54) PROJECTION NUT FEEDING DEVICE

(71) Applicant: Shoji AOYAMA, Osaka (JP)

(72) Inventors: Shoji AOYAMA, Osaka (JP); Yoshitaka AOYAMA, Osaka (JP)

(21) Appl. No.: 18/707,259

(22) PCT Filed: Jul. 12, 2022
(86) PCT No.: PCT/JP2022/027391

§ 371 Date: Oct. 30, 2024

(30) Foreign Application Priority Data
Dec. 7, 2021 (JP) 2021-209952

(51) Int. Cl. B23P 19/06; B23K 11/30

(52) U.S. Cl. CPC B23P 19/06; B23K 11/30

(57) ABSTRACT

A feed rod 7 configured with a hollow main rod 20 and a guide rod 21 put in the main rod 20. An advance and retraction type electric motor 33 is provided which outputs in the same direction as the feed rod 7 and can set an advance stop position of the feed rod 7 at an arbitrary position. An extension member 42 extending in the direction opposite to an advance direction of the main rod 20 is formed, and a detection object member 48 to be detected by a sensor 51 is attached to the extension member 42. The fixing structure of the sensor 51 is configured such that the sensor 51 can be fixed at an arbitrary position on a long stationary member 53 or 62 disposed along the advance and retraction operation direction of the feed rod 7.

### TECHNICAL FIELD

The present invention relates to a projection nut feeding device in which a guide rod is put through a screw hole of a projection nut and the projection nut is fed to an electrode for electric resistance welding.

### BACKGROUND ART

Patent Literatures 1 and 2 below describe that a feed rod for feeding a projection nut is advanced and retracted using an advance and retraction type electric motor.

### CITATIONS LIST

### Patent Literatures

Patent Literature 1: JP 2002-172470 A

Patent Literature 2: JP 2018-069331 A

### SUMMARY OF INVENTION

### Technical Problems

In the inventions described in Patent Literatures 1 and 2, it is possible to secure an advance and retraction stroke of the feed rod by using the advance and retraction type electric motor, and it is possible to take a safety measure when the hand of a worker is caught by a tip part of the feed rod. However, the above safety measure is not performed at all points in the entire stroke range of the feed rod. That is, it is impossible to perform the safety measure for each advance and retraction stroke obtained by a setting means such as an encoder.

The present invention has been provided to solve the above problem, and an object of the present invention is to cause a structure for safety measure to function at an arbitrary point in the entire advance and retraction stroke range, of a feed rod, set by an advance and retraction type electric motor.

### Solutions to Problems

A projection nut feeding device of the present invention is characterized in that, in a projection nut feeding device of a type in which a guide rod of a feed rod that performs an advance and retraction operation is put through a screw hole of a projection nut stopping at a predetermined position to feed the projection nut to an electrode for electric resistance welding, the feed rod is formed in a state where the guide rod is put in a hollow main rod,
a compression coil spring that applies elastic force, in an extrusion direction, to the guide rod is disposed in the main rod,
an advance and retraction type electric motor is provided that outputs in a direction parallel to an advance and retraction operation direction of the feed rod and that sets an advance stop position of the feed rod to an arbitrary position,
an advance and retraction output member that advances and retracts by the advance and retraction type electric motor is coupled to the main rod to cause an advance and retraction operation of the advance and retraction type electric motor and an advance and retraction operation of the feed rod to be simultaneously performed,
an extension member extending in a direction opposite to an advance direction of the main rod is formed by extension of the guide rod or by a joining member integrated into the guide rod,
a detection object member to be detected by a sensor is attached to the extension member,
a fixing structure of the sensor is configured to allow the sensor to be fixed at an arbitrary position on a long stationary member disposed along the advance and retraction operation direction of the feed rod, and a relative displacement generated between the guide rod and the main rod by abutting of a tip part of the guide rod against a foreign object including a hand of a worker or a hand tool when the feed rod advances is detected by the sensor.

### Advantageous Effects of Invention

It is necessary to take a measure such that a serious injury does not occur when a situation occurs in which a foreign object such as a hand of a worker or a hand tool is caught by a tip part of a guide rod in a feed rod whose advance and retraction length is set by an advance and retraction type electric motor even in a case where the advance and retraction length of the feed rod is set to any length. For this purpose, it is necessary to reliably detecting that the above foreign object is caught by the tip part of the guide rod so that occurrence of a serious injury can be prevented. In particular, this is important when the advance and retraction length of the feed rod is set to be long.

Since the feed rod has a basic structure in which the guide rod is put in a hollow main rod, when a detection object member is attached to the rearmost end position of the main rod, which is the rearmost end of the feed rod, it is impossible to secure a sufficient distance between the detection object member and a sensor as viewed in the advance and retraction direction of the feed rod.

In the present invention, an extension member extending in the direction opposite to the advance direction of the main rod is formed by extending the guide rod itself or by a joining member integrated into the guide rod, and the detection object member is attached to the extension member. Therefore, even in a case where the advance and retraction length of the feed rod is significantly long, the length, of the extension member, corresponding to the advance and retraction length of the feed rod is added to the guide rod, and even when a foreign object is caught at the time of long distance advance and retraction of the feed rod, it is possible to reliably detect the catching of the foreign object and to prevent occurrence of a serious injury by prohibiting the electrode from advancing or by other measures. As a result, a sufficient distance is secured between the above detection object member and the sensor.

With an encoder or the like, it is possible to accurately obtain a plurality of long or short distances with respect to the distance of advance and retraction of the advance and retraction type electric motor. Thus, the feed rod also advances and retracts in an interlocking manner. Therefore, the distance of advance and retraction of the feed rod can be freely and accurately selected to be adaptive to a neighboring space environment or the like. It is possible to reliably detect catching of a foreign object for each advance distance, of the feed rod, selected in this manner and to prevent occurrence of a serious injury by prohibiting the electrode from advancing or by other measures.

Depending on the shape or the like of a steel plate component to which a projection nut is welded, it is sometimes necessary to set the advance and retraction length of the feed rod to be significantly long. In such a case, in the present invention, since the extension member extending in the direction opposite to the advance direction of the main rod is adopted, it is possible to lengthen the feed rod without impairing detection performance.

Since the detection object member is attached to the extension member, the detection object member can be present at the most retracted position of the feed rod, and since a fixing structure of the sensor is configured such that the sensor can be fixed at an arbitrary position on a long stationary member disposed along the advance and retraction operation direction of the feed rod, the sensor can be present at the most advanced position of the feed rod. By matching (i) the maximum interval between the above most retracted position of the detection object member and the most advanced position of the sensor and (ii) the advance and retraction length of the feed rod, it is possible to determine the fixing position of the sensor suitable for the advance and retraction length, of the advance and retraction type electric motor, selected by the encoder or the like and to appropriately cope with intervention of a hand of a worker or a hand tool and other incidents for each advance length of the feed rod.

In other words, the advance length of the feed rod is set to various lengths in consideration of space conditions and the like, but since the fixing place of the sensor is selected for each advance length of the feed rod, a safety structure adapted to the advance and retraction length of the feed rod can always be secured.

The range of the advance and retraction length of the detection object member can be the same as the maximum advance and retraction length of the feed rod. Within a length range equal to or shorter than the maximum advance and retraction length of the feed rod, the advance length of the feed rod is precisely obtained by an encoder or the like. Then, the fixing position of the sensor is selected to be adaptive to the obtained advance length of the feed rod. Therefore, it is easy to accurately set the advance length of the feed rod by using the encoder or the like, and, at the same time, when the feed rod abuts a hand of a worker, a hand tool, or the like, the abnormality can be reliably detected for each of the set advance lengths of the feed rod.

Since the detection object member is attached to the extension member, the detection object member can be located at the most retracted position of the feed rod, and a detection length range of the detection object member can be sufficiently extended. For this reason, it is easy to feed a projection nut to a distant target location by increasing the advance and retraction length of the feed rod.

The fixing structure of the sensor is configured such that the sensor can be fixed at an arbitrary position on a long stationary member disposed along the advance and retraction operation direction of the feed rod. Therefore, the fixing position of the sensor can be set at any position within a range of the maximum advance and retraction length of the feed rod in correspondence to whether the length of the advance and retraction length of the feed rod is long or short. Therefore, it is reliably determined whether the advance position of the feed rod is normal for each advance and retraction length of the feed rod.

An advance and retraction output member that is advanced and retracted by the advance and retraction type electric motor is coupled to the main rod, an extension member extending in the direction opposite to the advance direction of the main rod is formed by extending the guide rod itself or by a joining member integrated into the guide rod, and the detection object member, which is detected by a sensor, is attached to the extension member. In addition, the sensor has a fixing structure in which the sensor is fixed at an arbitrary position on a long stationary member arranged along the advance and retraction operation direction of the feed rod so that the sensor can be fixed at an arbitrary position along the advance and retraction operation direction of the advance and retraction type electric motor. Therefore, the long stationary member can be formed of a straight and elongated plate member having a slide gap, a straight and elongated rod member, or the like, and the adjustment position can be easily and reliably obtained.

Although the advance length of the feed rod varies depending on the surrounding space environment or the like, the advance and retraction length of the feed rod by the advance and retraction type electric motor is freely set using an operation setting means such as an encoder. By fixing the sensor at a position corresponding to the advance length, of the feed rod, set in this manner, when the feed rod advances normally, the detection object member, which is attached to the extension member, stops at the position facing the sensor, and it is confirmed by a signal from the sensor that the projection nut is correctly fed to the electrode.

The sensor detects an abnormal relative displacement generated between the guide rod and the main rod when the tip part of the guide rod abuts a foreign object such as a hand of a worker or a hand tool. By detecting such an abnormal relative displacement, it is possible to prohibit of an advance operation of the electrode and to secure safety.

The detection object member can be disposed at the most retracted position of the advance and retraction type electric motor, in other words, the most retracted position of the feed rod, and the sensor can be disposed at the most advanced position of the advance and retraction type electric motor, in other words, the most advanced position of the feed rod. Therefore, by selecting, within the range of the maximum advance and retraction length of the feed rod, the advance and retraction length of the advance and retraction type electric motor by using an encoder or the like such that the advance and retraction length of the advance and retraction type electric motor is adapted to a necessary advance length of the feed rod, it is possible to flexibly cope with the change in the advance length of the feed rod even when the advance length of the feed rod changes variously depending on the surrounding space environment.

In order to advance and retract the feed rod, an advance and retraction driving means such as an air cylinder is generally used, but the advance and retraction length obtained in such an arrangement is only one length obtained by the most advancing position and the most retracted position of the air cylinder; therefore, the advance and retraction length of the feed rod is also limited. Alternatively, in the case of the advance and retraction type electric motor, the advance and retraction length can be changed in a minute region, which is advantageous in diversification of the operation of the feed rod. Then, it is possible to exert the function of the sensor corresponding to the selected advance and retraction length of the feed rod, which is effective for improving reliability in feeding of the projection nut.

The present invention is a projection nut feeding device, but can also be made to exist as an invention of a method focusing on a feeding operation to be described later.

### BRIEF DESCRIPTION OF DRAWINGS

FIG. 1A is a cross-sectional view of an entire device.

FIG. 1B is a plan view illustrating a part of an adjustment guide member.

FIG. 1C is a cross-sectional view taken along line C-C in FIG. 1A.

FIG. 1D is a cross-sectional view illustrating a part of a tubular member.

FIG. 2 is a cross-sectional view illustrating a variation of an extension member.

FIG. 3 is a cross-sectional view illustrating a variation of a fixing structure for a sensor.

FIG. 4A is an operation state diagram when a distance L2 between a detection object member and a sensor is set to the maximum length.

FIG. 4B is an operation state diagram when the above distance L2 is set to a shortened distance L3.

FIG. 4C is an operation state diagram when a finger of a worker is pinched between a guide rod and a guide pin.

### DESCRIPTION OF EMBODIMENT

Hereinafter, a mode for implementing a projection nut feeding device of the present invention will be described.

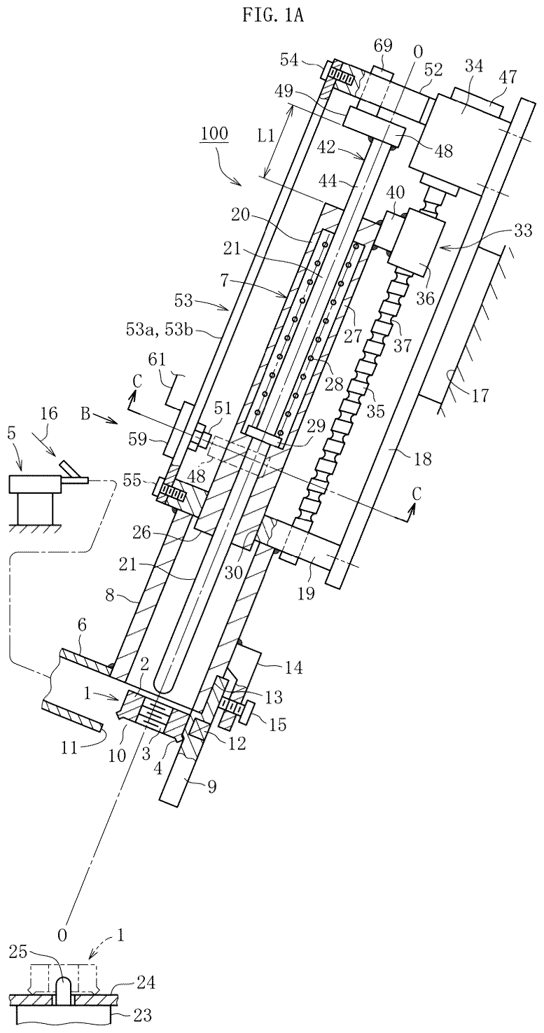

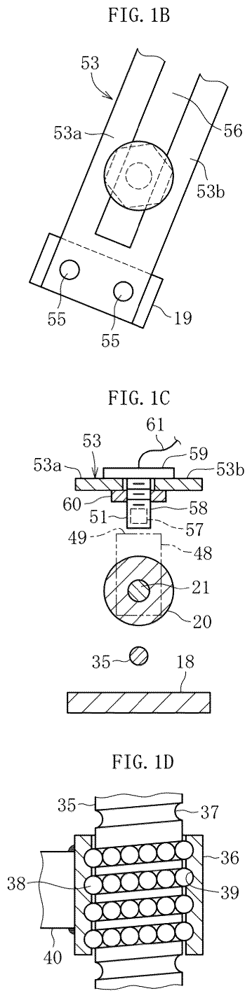

FIGS. 1A to 4C show an embodiment of the present invention.

The entire feeding device is denoted by a reference sign 100 and is arranged in an inclined attitude as shown in FIG. 1A.

First, the projection nut will be described.

As illustrated in FIG. 1A, a projection nut 1 made of iron is formed with a screw hole 3 in a central part of a square rectangular nut body 2, and welding protrusions 4 are provided at four corners on one side. In the following description, the projection nut may be simply referred to as a nut.

Next, positioning of the projection nut will be described.

A component feed pipe 6 extending from a part feeder 5 and a guide pipe 8 of a feed rod 7 are coupled in an orthogonal state, and a guide plate 9 for positioning a nut 1 is fixed to an end part of the guide pipe 8. The component feed pipe 6, the guide pipe 8, and the guide plate 9 constitute a temporary stop chamber 10. An outlet opening 11 is formed in the temporary stop chamber 10 on the side from which the feed rod 7 advances. The nut 1 is drawn into the temporary stop chamber 10 by a permanent magnet 12 attached to the guide plate 9, and positioning is performed by the attraction force of the permanent magnet 12. The positioning is performed such that the center line of the screw hole 3 is coaxial with a center axis O-O of the feed rod 7.

The component feed pipe 6 and the guide pipe 8 may be coupled by bolt fixing, but welding is employed here. In each drawing of the present embodiment, parts filled in black indicate that the parts are welded.

A flat surface 13 is formed on an outer peripheral surface of the guide pipe 8, and the guide plate 9 is pressed against and fixed to the flat surface 13. A pressing member 14 is welded to the guide pipe 8, and a fixing bolt 15 is screwed into the pressing member 14, so that the guide plate 9 is pressed against the flat surface 13. Note that conveyance air indicated by an arrow line 16 is blown into an outlet part of the part feeder 5 so that the nut 1 is sent into the temporary stop chamber 10.

Next, the feed rod will be described.

An elongated substrate 18 is coupled to a stationary member 17 formed of a machine frame or the like of the feed device, and the feed rod 7 is supported to be capable of advancing and retracting by a block-shaped or thick plate-shaped support member 19 fixed to an end part of the substrate 18. A basic structure of the feed rod 7 is in a state where a guide rod 21 is put in a hollow main rod 20. The feed rod 7 advances to make the guide rod 21 pass through the screw hole 3 of the nut 1 positioned in the temporary stop chamber 10.

A steel plate component 24 is placed on a fixed electrode 23, and a guide pin 25 protrudes through a prepared hole formed in the steel plate component 24.

When the feed rod 7 advances, the guide rod 21 passes through the screw hole 3 of the nut 1, and a push-out surface 26 provided at the lower end of the main rod 20 comes into contact with the upper surface of the nut 1, the nut 1 slides down the advanced guide rod 21 and is transferred to the guide pin 25 side as illustrated by a two-dot chain line.

A compression coil spring 28 is assembled in a hollow pipe portion 27 of the main rod 20. The upper end of the compression coil spring 28 is received by the inner end surface of the hollow pipe portion 27, and the lower end of the compression coil spring 28 is received by a flange 29 fixed to the guide rod 21. In addition, the main rod 20 passes through a guide hole 30 provided in the support member 19 in a slidable state. The flange 29 is pressed against the inner end surface of the lower hollow pipe portion 27 by the tension of the compression coil spring 28.

The guide rod 21 passes through the main rod 20 in a slidable state at a place other than the hollow pipe portion 27.

Next, the extension member will be described.

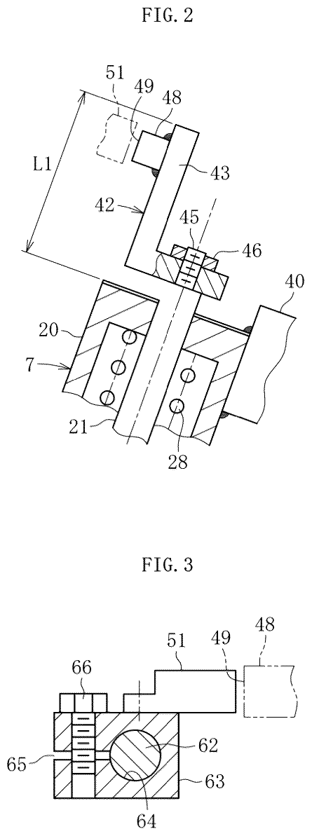

An extension member 42 is configured to extend in the direction opposite to the advance direction of the main rod 20 by an extension of the guide rod 21 itself or by a joining member 43 (see FIG. 2) integrated into the guide rod 21.

When the guide rod 21 itself is extended, the guide rod 21 is made to protrude from the end part of the main rod 20, and a protruding portion 44 constitutes the extension member 42. The extension length is denoted by reference sign L1.

As illustrated in FIG. 2, when the extension member 42 is configured with the joining member 43 integrated into the guide rod 21, the L-shaped joining member 43 is joined to the guide rod 21 protruding from the end part of the main rod 20. As a method for this connection, various methods such as welding and bolt fixing can be adopted. Here, a bolt-nut type is adopted. That is, a bolt 45 is formed at the end part of the guide rod 21 to protrude from the end part of the main rod 20, and the bolt 45 is put through the joining member 43 and is tightened with a fixing nut 46. In this manner, the extension length denoted by reference sign L1 is secured.

Next, advance and retraction driving of the feed rod will be described.

The advance and retraction operation of the feed rod 7 is performed by an advance and retraction type electric motor in which an advance and retraction length can be freely selected. As the advance and retraction type electric motor, various types of motors can be adopted, such as a motor in which a rack and pinion mechanism is advanced and retracted by a rotation output type motor and a motor in which a screw shaft is rotated to perform an advance and retraction operation.

An advance and retraction type electric motor 33 is attached to the substrate 18. The advance and retraction type electric motor 33 includes: an electric motor 34; a screw shaft 35 rotated by the electric motor 34; a tubular member 36; steel balls 38 inside, and the like. The screw shaft 35 is parallel to the center axis O-O of the feed rod 7.

As shown in FIGS. 1A and 1D, a spiral groove 37 is formed in the screw shaft 35, and a large number of steel balls 38 are received therein. A spiral groove 39 is formed in the inner surface of the tubular member 36 through which the screw shaft 35 passes, and the steel balls 38 are fitted in both the spiral grooves 37 and 39. Therefore, when the screw shaft 35 rotates, the tubular member 36 advances and retracts in a center axis O-O direction. Note that the lower end part of the screw shaft 35 is rotatably supported by the support member 19.

In order to transmit an advance and retraction operation of the tubular member 36 to the feed rod 7, an advance and retraction output member 40 is provided. The advance and retraction output member 40 is a member that couples the main rod 20 and the tubular member 36. Instead of the member 40, the main rod 20 can be directly coupled to the tubular member 36, and the tubular member 36 itself can be made to be the advance and retraction output member 40.

With respect to the advance and retraction length of the advance and retraction type electric motor 33, in other words, the advance and retraction length of the feed rod 7, a mechanism that obtains a predetermined advance and retraction length by causing the electric motor 34 to rotate at a predetermined rotation speed is generally adopted, and an encoder 47 is utilized in the present embodiment.

Next, the detection object member will be described.

A detection object member 48 made of iron can function in various shapes such as a plate-like member and a bar-like member. Here, the detection object member 48 is configured with a rectangular parallelepiped member, and is welded to the rearmost end of the guide rod 21. In the case of the joining member 43 shown in FIG. 2, the detection object member 48 is formed of a substantially cubic member. When a detection object surface 49 of the detection object member 48 faces a sensor 51 to be described later, it is detected that the feed rod 7 has advanced to a predetermined position.

Next, the sensor will be described.

As a sensor 51, various types of sensors can be adopted, but here, a proximity switch type sensor is used that detects that the detection object member 48 enters a magnetic field. As illustrated in FIGS. 1A and 1C, when the feed rod 7 advances over a predetermined length and the detection object surface 49 of the detection object member 48 faces the sensor 51, a normal advance state of the feed rod 7 is detected from the sensor 51, a signal of the normal advance state is input to a control device (not illustrated) via a signal line 61, and a movable electrode is allowed to advance.

Next, a sensor position adjustment structure will be described.

Since the sensor 51 is moved to be adapted to the advance length of the feed rod 7 and detects that the guide rod 21 has interfered with a foreign object, position adjustment of the sensor 51 is performed by moving the sensor 51 in the direction parallel to the center axis O-O. A long adjustment guide member 53 is stretched between an end part of the bracket member 52 fixed to the electric motor 34 by bolt fixing or the like and an end part of the support member 19. The adjustment guide member 53 here is made of an elongated plate member. The end parts are respectively fixed with fixing bolts 54 and 55. The long adjustment guide member 53 is parallel to the center axis O-O of the feed rod 7.

If the feed rod 7 is fully retracted and stopped for a long time, the screw shaft 35 may be rotated by a weight of the feed rod 7, and the feed rod 7 may descend. To address this issue, a permanent magnet 69 is fixed to the bracket member 52 so that the detection object member 48 is attracted upward.

As illustrated in FIGS. 1B and 1C, in the adjustment guide member 53, long members 53a and 53b are disposed in parallel, and an elongated movement space 56 is formed between the long members 53a and 53b. As indicated by a chain line in FIG. 1C, a sensor element 57 is embedded near the tip of a bolt 58, and the long members 53a and 53b are pinched between a flange 59 integrated with the bolt 58 and a fixing nut 60. The fixing nut 60 is loosened to move the sensor 51 along the movement space 56, and the fixing nut 60 is tightened at a predetermined position.

FIG. 3 illustrates a sensor position adjustment structure of another type. A rod member 62 that has a circular cross-section and corresponds to the above-described adjustment guide member 53 is fixed to the bracket member 52 and the support member 19 in a state of being parallel to the center axis O-O. A through-hole 64 is formed in a rectangular parallelepiped clamp member 63, and the rod member 62 passes through the through-hole 64. The sensor 51 is fixed to the clamp member 63. A split groove 65 is formed in the clamp member 63 to reach the through-hole 64, and a fastening bolt 66 is screwed at a place of the split groove 65 so as to fasten the rod member 62 with the inner surface of the through-hole 64, so that the clamp member 63 is firmly fixed to the rod member 62.

Position adjustment of the sensor 51 is performed in such a manner that the fastening bolt 66 is loosen to move the clamp member 63 along the rod member 62 and is then fastened at a predetermined position.

The above adjustment guide member 53 and the rod member 62 correspond to a long stationary member stretched between the bracket member 52 and the support member 19.

Next, an operation of the device will be described.

In the operation to be described later, an activation switch operated by a worker, a signal from the activation switch, a signal generated by facing of the detection object member and the sensor, a signal caused by displacement, of the relative position between the detection object member and the sensor, caused by interfering of the guide rod with a foreign object, and the like are input to a control device configured with a sequence circuit or a simple computer device, and advance of the movable electrode is allowed or prohibited by a signal processed in the control device.

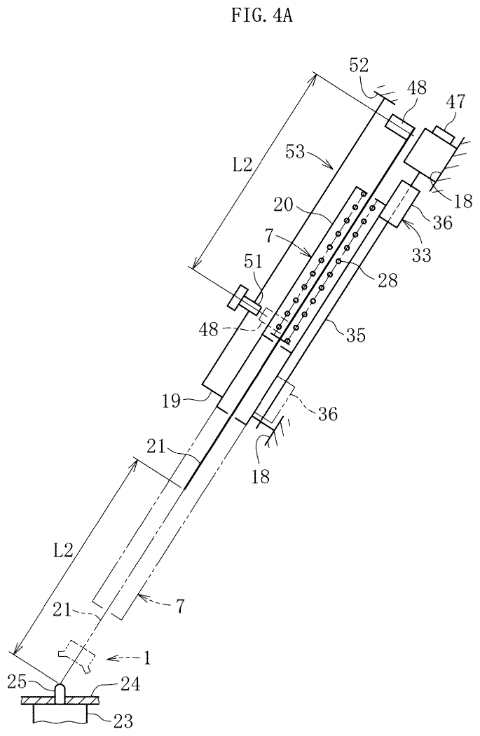

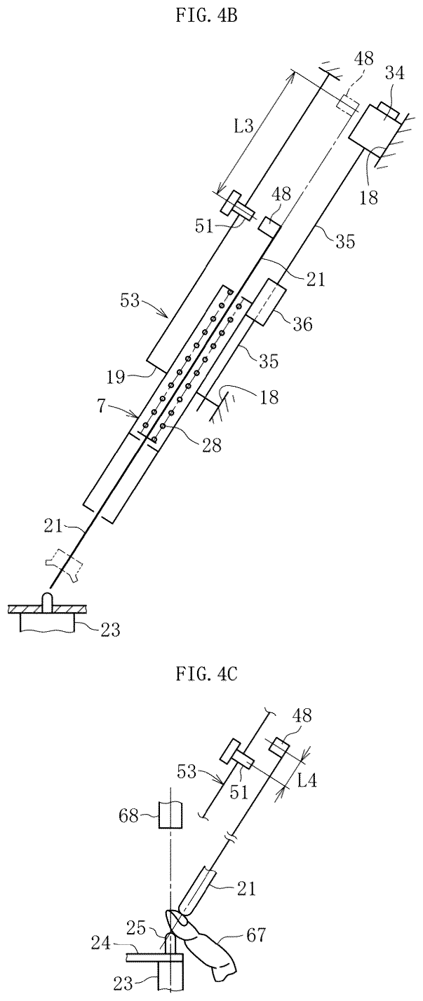

FIG. 4A illustrates a most retracted state of the advance and retraction type electric motor 33, in which state the tubular member 36 is fully retracted by the rotation of the screw shaft 35. Along with this retraction, the feed rod 7 is also placed at the most retracted position. The advance length of the feed rod 7 here is set to the longest length by a setting value of the encoder 47, and the distance L2 between the detection object member 48 and the sensor 51 is set to the maximum length. At the same time, the distance between the tip of the guide rod 21 and the guide pin 25 of the fixed electrode 23 is also equal to the above L2.

Next, the feed rod 7 advances by the operation of the advance and retraction type electric motor 33, the tip part of the guide rod 21 stops immediately before the guide pin 25, and the nut 1 slides down the guide rod 21 and is fitted to the guide pin 25. This stroke is a normal stroke in which there is no interference with a foreign object, and at a time when the feed rod 7 has stopped, the detection object member 48 faces the sensor 51 as indicated by a two-dot chain line, and a signal issued by this facing causes the movable electrode to advance.

When the nut 1 is normally fed, the device performs a reverse operation to prepare for the next nut feeding.

FIG. 4B illustrates a state where the distance corresponding to the above L2 is shortened, the feed rod 7 has normally advanced, and the detection object member 48 faces the sensor 51. In FIG. 4B, a distance L3 between the detection object member 48 and the sensor 51 when the feed rod 7 is at the most retracted position is shorter than the above L2. The distance is determined by selecting a setting value of the encoder 47 and the fixing position of the sensor 51.

FIG. 4C illustrates a state in which a finger 67 of a worker is pinched between the guide rod 21 and the guide pin 25. The tip end of the guide rod 21 abuts the finger and stops as described above, and, on the other hand, the main rod 20 advances, so that the compression coil spring 28 is compressed. That is, a relative displacement L4 is formed between the main rod 20 and the guide rod 21. When the feed rod 7 advances by a predetermined length in this manner, no signal is issued from the sensor 51. Such a case is detected in the following manner: in the control device, it is detected by a timer switch or the like that the signal of the sensor 51 is not issued even after a certain period of time has elapsed since the main rod 20 completes a predetermined stroke. A signal of this detection is used as a trigger signal to prohibit a movable electrode 68 from advancing, and it is possible to avoid the worst case where the finger 67 is caught by the movable electrode 68.

Although not illustrated, even in a case where a hand tool such as a spanner or pliers is pinched like the finger 67, a similar detection operation is performed.

The actions and effects of the embodiment described above are as follows.

It is necessary to take a measure such that a serious injury does not occur when a situation occurs in which a foreign object such as a hand 67 of a worker or a hand tool is caught by the tip part of the guide rod 21 in the feed rod 7 whose advance and retraction length is set by the advance and retraction type electric motor 33 even in a case where the advance and retraction length of the feed rod 7 is set to any length. For this purpose, it is necessary to reliably detecting that the above foreign object is caught by the tip part of the guide rod 21 so that occurrence of a serious injury can be prevented. In particular, this is important when the advance and retraction length of the feed rod 7 is set to be long.

Since the feed rod 7 has a basic structure in which the guide rod 21 is put in the hollow main rod 20, in the case where the detection object member 48 is attached to the rearmost end position of the main rod 20, which is the rearmost end of the feed rod 7, it is impossible to secure a sufficient distance between the detection object member 48 and the sensor 51 as viewed in the advance and retraction direction of the feed rod 7.

In the present embodiment, the extension member 42 extending in the direction opposite to the advance direction of the main rod 20 is formed by extending the guide rod 21 itself or by the joining member 43 integrated into the guide rod 21, and the detection object member 48 is attached to the extension member 42. Therefore, even in a case where the advance and retraction length of the feed rod 7 is significantly long, the length L1, of the extension member 42, corresponding to the advance and retraction length of the feed rod 7 is added to the guide rod 21, and even when a foreign object is caught at the time of long distance advance and retraction of the feed rod 7, it is possible to reliably detect the catching of the foreign object and to prevent occurrence of a serious injury by prohibiting the electrode from advancing or by other measures. As a result, a sufficient distance is secured between the above detection object member 48 and the sensor 51.

With the encoder 47 or the like, it is possible to accurately obtain a plurality of long or short distances with respect to the distance of advance and retraction of the advance and retraction type electric motor 33. Thus, the feed rod 7 also advances and retracts in an interlocking manner. Therefore, the distance of advance and retraction of the feed rod 7 can be freely and accurately selected to be adaptive to a neighboring space environment or the like. It is possible to reliably detect catching of a foreign object for each advance distance, of the feed rod 7, selected in this manner and to prevent occurrence of a serious injury by prohibiting the electrode from advancing or by other measures.

Depending on the shape or the like of a steel plate component 24 to which the projection nut 1 is welded, it is sometimes necessary to set the advance and retraction length of the feed rod 7 to be significantly long. In such a case, in the present embodiment, since the extension member 42 extending in the direction opposite to the advance direction of the main rod 20 is adopted, it is possible to lengthen the feed rod 7 without impairing detection performance.

Since the detection object member 48 is attached to the extension member 42, the detection object member 48 can be present at the most retracted position of the feed rod 7, and since the fixing structure of the sensor 51 is configured such that the sensor can be fixed at an arbitrary position on the long stationary member 53 or 62 disposed along the advance and retraction operation direction of the feed rod 7, the sensor 51 can be present at the most advanced position of the feed rod 7. By matching (i) the maximum interval L2 between the above most retracted position of the detection object member 48 and the most advanced position of the sensor 51 and (ii) the advance and retraction length of the feed rod 7, it is possible to determine the fixing position of the sensor 51 suitable for the advance and retraction length, of the advance and retraction type electric motor 33, selected by the encoder 47 or the like and to appropriately cope with intervention of a hand 67 of a worker or a hand tool and other incidents for each advance length of the feed rod 7.

In other words, the advance length of the feed rod 7 is set to various lengths in consideration of space conditions and the like, but since the fixing place of the sensor 51 is selected for each advance length of the feed rod 7, a safety structure adapted to the advance and retraction length of the feed rod 7 can always be secured.

The range of the advance and retraction length of the detection object member 48 can be the same as the maximum advance and retraction length L2 of the feed rod 7. Within a length range equal to or shorter than the maximum advance and retraction length L2 of the feed rod 7, the advance length of the feed rod 7 is precisely obtained by an encoder 47 or the like. Then, the fixing position of the sensor 51 is selected to be adaptive to the obtained advance length of the feed rod 7. Therefore, it is easy to accurately set the advance length of the feed rod 7 by using the encoder 47 or the like, and, at the same time, when the feed rod 7 abuts a hand 67 of a worker, a hand tool, or the like, the abnormality can be reliably detected for each of the set advance lengths of the feed rod 7.

Since the detection object member 48 is attached to the extension member 42, the detection object member 48 can be located at the most retracted position of the feed rod 7, and a detection length range of the detection object member 48 can be sufficiently extended. For this reason, it is easy to feed the projection nut 1 to a distant target location by increasing the advance and retraction length of the feed rod 7.

The fixing structure of the sensor 51 is configured such that the sensor 51 can be fixed at an arbitrary position on the long stationary member 53 or 62 disposed along the advance and retraction operation direction of the feed rod 7. Therefore, the fixing position of the sensor 51 can be set at any position within the range of the maximum advance and retraction length of the feed rod 7, in correspondence to whether the length of the advance and retraction length of the feed rod 7 is long or short. Therefore, it is reliably determined whether the advanced position of the feed rod 7 is normal for each advance and retraction length of the feed rod 7.

The advance and retraction output member 40 that is advanced and retracted by the advance and retraction type electric motor 33 is coupled to the main rod 20, the extension member 42 extending in the direction opposite to the advance direction of the main rod 20 is formed by extending the guide rod 21 itself or by the joining member 43 integrated into the guide rod 21, and the detection object member 48, which is detected by the sensor 51, is attached to the extension member 42. In addition, the sensor 51 has a fixing structure in which the sensor 51 is fixed at an arbitrary position on the long stationary member 53 or 62 arranged along the advance and retraction operation direction of the feed rod 7 so that the sensor 51 can be fixed at an arbitrary position along the advance and retraction operation direction of the advance and retraction type electric motor 33. Therefore, the long stationary member 53 or 62 can be formed of the straight and elongated plate member (53a, 53b) having the slide gap (movement space 56), the straight and elongated rod member 62, or the like, and the adjustment position can be easily and reliably obtained.

Although the advance length of the feed rod 7 varies depending on the surrounding space environment or the like, the advance and retraction length of the feed rod 7 by the advance and retraction type electric motor 33 is freely set using an operation setting means such as an encoder 47. By fixing the sensor 51 at a position corresponding to the advance length, of the feed rod 7, set in this manner, when the feed rod 7 advances normally, the detection object member 48, which is attached to the extension member 42, stops at the position facing the sensor 51, and it is confirmed by a signal from the sensor 51 that the projection nut 1 is correctly fed to the fixed electrode 23.

The sensor 51 detects an abnormal relative displacement L4 generated between the guide rod 21 and the main rod 20 when the tip part of the guide rod 21 abuts a foreign object such as a hand 67 of a worker or a hand tool. By detecting such an abnormal relative displacement L4, it is possible to prohibit of an advance operation of the movable electrode 68 and to secure safety.

The detection object member 48 can be disposed at the most retracted position of the advance and retraction type electric motor 33, in other words, the most retracted position of the feed rod 7, and the sensor 51 can be disposed at the most advanced position of the advance and retraction type electric motor 33, in other words, the most advanced position of the feed rod 7. Therefore, by selecting, within the range of the maximum advance and retraction length of the feed rod 7, the advance and retraction length of the advance and retraction type electric motor 33 by using the encoder 47 or the like such that the advance and retraction length of the advance and retraction type electric motor 33 is adapted to a necessary length of the feed rod 7, it is possible to flexibly cope with the change in the advance length of the feed rod even when the advance length of the feed rod 7 changes variously depending on the surrounding space environment.

In order to advance and retract the feed rod 7, an advance and retraction driving means such as an air cylinder is generally used, but the advance and retraction length obtained in such an arrangement is only one length obtained by the most advancing position and the most retracted position of the air cylinder; therefore, the advance and retraction length of the feed rod 7 is also limited. Alternatively, in the case of the advance and retraction type electric motor 33, the advance and retraction length can be changed in a minute region, which is advantageous in diversification of the operation of the feed rod 7. Then, it is possible to exert the function of the sensor 51 corresponding to the selected advance and retraction length of the feed rod 7, which is effective for improving reliability in feeding of the projection nut 1.

The advance and retraction type electric motor 33, the feed rod 7, and the adjustment guide member 53 or 62 are disposed in parallel between the bracket member 52 and the support member 19 disposed at both ends of the substrate 18. Therefore, the main three members of the advance and retraction type electric motor 33, the feed rod 7, and the adjustment guide member 53 or 62 are compactly disposed, which is effective for downsizing the device.

### INDUSTRIAL APPLICABILITY

As described above, with the device of the present invention, it is possible to cause a structure for safety measure to function at an arbitrary position in the entire advance and retraction stroke range, of a feed rod, set by an advance and retraction type electric motor. Therefore, the device of the present invention can be used in a wide industrial field such as a vehicle body welding process of automobiles and a sheet metal welding process of electric home appliances.

### REFERENCE SIGNS LIST

1 Projection nut
2 Nut body
3 Screw hole
4 Welding protrusion
6 Component feed pipe
7 Feed rod
8 Guide pipe
10 Temporary stop chamber
18 Substrate
19 Support member
20 Main rod
21 Guide rod
23 Fixed electrode
24 Steel plate component
25 Guide pin
27 Hollow pipe portion
28 Compression coil spring
33 Advance and retraction type electric motor
34 Electric motor
35 Screw shaft
36 Tubular member
37 Spiral groove
38 Steel ball
39 Spiral groove
40 Advance and retraction output member
42 Extension member
43 Joining member
44 Protruding portion
47 Encoder
48 Detection object member
49 Detection object surface
51 Sensor
53 Adjustment guide member
53a Long member
53b Long member
57 Sensor element
62 Rod member
63 Clamp member
67 Finger
68 Movable electrode
100 Feeding device
0-0 Center axis of feed rod
L1 Extension length
L2 Maximum interval between detection object member and sensor
L3 Shortened length between detection object member and sensor
L4 Length of relative displacement

1. A projection nut feeding device in which a guide rod of a feed rod that performs an advance and retraction operation is put through a screw hole of a projection nut stopping at a predetermined position to feed the projection nut to an electrode for electric resistance welding, wherein the feed rod is formed in a state where the guide rod is put in a hollow main rod,
a compression coil spring that applies elastic force, in an extrusion direction, to the guide rod is disposed in the main rod,
an advance and retraction type electric motor is provided that outputs in a direction parallel to an advance and retraction operation direction of the feed rod and that sets an advance stop position of the feed rod to an arbitrary position,
an advance and retraction output member that advances and retracts by the advance and retraction type electric motor is coupled to the main rod to cause an advance and retraction operation of the advance and retraction type electric motor and an advance and retraction operation of the feed rod to be simultaneously performed,
an extension member extending in a direction opposite to an advance direction of the main rod is formed by extension of the guide rod or by a joining member integrated into the guide rod,
a detection object member to be detected by a sensor is attached to the extension member,
a fixing structure of the sensor is configured to allow the sensor to be fixed at an arbitrary position on a long stationary member disposed along the advance and retraction operation direction of the feed rod, and a relative displacement generated between the guide rod and the main rod by abutting of a tip part of the guide rod against a foreign object including a hand of a worker or a hand tool when the feed rod advances is detected by the sensor.
